(19) United States
(12) Patent Application Publication
(10) Pub. No.: US 2018/0039324 A1
(43) Pub. Date: Feb. 8, 2018

(54) METHOD FOR CONTROLLING A PLURALITY OF HARDWARE MODULES AND ASSOCIATED CONTROLLER AND SYSTEM

(71) Applicant: MEDIATEK INC., Hsin-Chu (TW)

(72) Inventors: Yen-Lin Lee, Hsinchu County (TW); Ming-Hsien Lee, Hsinchu City (TW); Tai-Ying Jiang, Hsinchu City (TW); Mark Shane Peng, Hsinchu County (TW); Hui-Hsuan Wang, Taoyuan City (TW); Jia-Horng Shieh, New Taipei City (TW); Chun-Yuan Lai, Hsinchu City (TW); Shin-Pen Chen, Hsinchu County (TW); Chung-Hua Yu, Kaohsiung City (TW)

(21) Appl. No.: 15/555,084

(22) PCT Filed: Oct. 23, 2015
(86) PCT No.: PCT/CN2015/092658

§ 371 Date: Sep. 1, 2017

Related U.S. Application Data
(60) Provisional application No. 62/144,308, filed on Apr. 7, 2015.
(60) Provisional application No. 62/127,349, filed on Mar. 3, 2015.

(51) Int. Cl. G06F 1/32

(52) U.S. Cl. CPC G06F 1/3296; G06F 1/3228

(57) ABSTRACT

A controller coupled to a plurality of hardware modules is arranged for determining activities of at least two of the hardware modules in real time, and determining a voltage and a frequency for one of the hardware modules according to the activities of the at least two of the hardware modules.

### CROSS REFERENCE TO RELATED APPLICATIONS

This application claims the priority of U.S. Provisional Application No. 62/144,308, filed on Apr. 7, 2015, which is included herein by reference in its entirety.

### BACKGROUND

Dynamic voltage and frequency scaling (DVFS) is an effective power management technique that is to adjust a clock frequency and a supply voltage according to circumstances of workload. The clock frequency and the supply voltage may be increased to allow the processor to operate at higher speed and to have better performance; and the clock frequency and the supply voltage may be decreased for power saving.

Because increasing the clock frequency and the supply voltage will consume more power, and decreasing the clock frequency and the supply voltage may lower the performance, a central challenge for developing DVFS schemes is to balance two competing objectives: maximizing the power saving and ensuring tight fine-grained performance. Conventional DVFS mechanism is controlled by software governor, however, using software governor to execute the DVFS operation may suffer some problems. For example, if the software DVFS governor operates with an aggressive DVFS policy, that is the software DVFS governor adjusts the clock frequency and the supply voltage at high sensitivity, it may induce more software overhead and impact the performance, and generally the performance drop is more serious for the user than the power saving. On the other hand, if the software DVFS governor operates with an non-aggressive DVFS policy, the software DVFS governor will control the clock frequency and the supply voltage to easily go up but difficultly go down, to keep higher DVFS to avoid performance drop, however, it will cause less power saving.

In addition, in the electronic device such as a smart phone, a plurality of processors are built in for complicated operations, however, the DVFS control of these processors are performed individually rather than adopting an overall arrangement, and the power saving and the system performance may not be optimized.

### SUMMARY

It is therefore an objective of the present invention to provide a fully hardware DVFS controller, which is able to maximize the power saving and ensure tight fine-grained performance, to solve the above-mentioned problems.

According to one embodiment of the present invention, a controller coupled to a plurality of hardware modules is arranged for determining activities of at least two of the hardware modules in real time, and determining a voltage and a frequency for one of the hardware modules according to the activities of the at least two of the hardware modules.

According to another embodiment of the present invention, a method for controlling a plurality of hardware modules comprises: determining activities of at least two of the hardware modules in real time; and determining a voltage and a frequency for one of the hardware modules according to the activities of the at least two of the hardware modules.

According to another embodiment of the present invention, a system comprises a plurality of hardware modules and a dynamic voltage frequency scaling (DVFS) controller. The DVFS controller is coupled to the plurality of hardware modules, and is arranged for determining activities of at least two of the hardware modules in real time, and determining a voltage and a frequency for one of the hardware modules according to the activities of the at least two of the hardware modules.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram illustrating a system on chip (SOC) according to one embodiment of the present invention.

FIG. 2 is a diagram illustrating the centralized DVFS controller shown in FIG. 1 according to one embodiment of the present invention.

FIG. 3 shows an overall arrangement of the DVFS OPPs according to one embodiment of the present invention.

FIG. 4 is a diagram illustrating the detailed operations of the embodiment shown in FIG. 2, and is using CPU as an example.

FIG. 5 is a flowchart of a method for controlling a plurality of hardware modules according to one embodiment of the present invention.

FIG. 6 shows a diagram illustrating the distinction between the performance requirement, the DVFS OPP status controlled by the centralized DVFS controller, and the DVFS OPP status controlled by a software DVFS controller according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

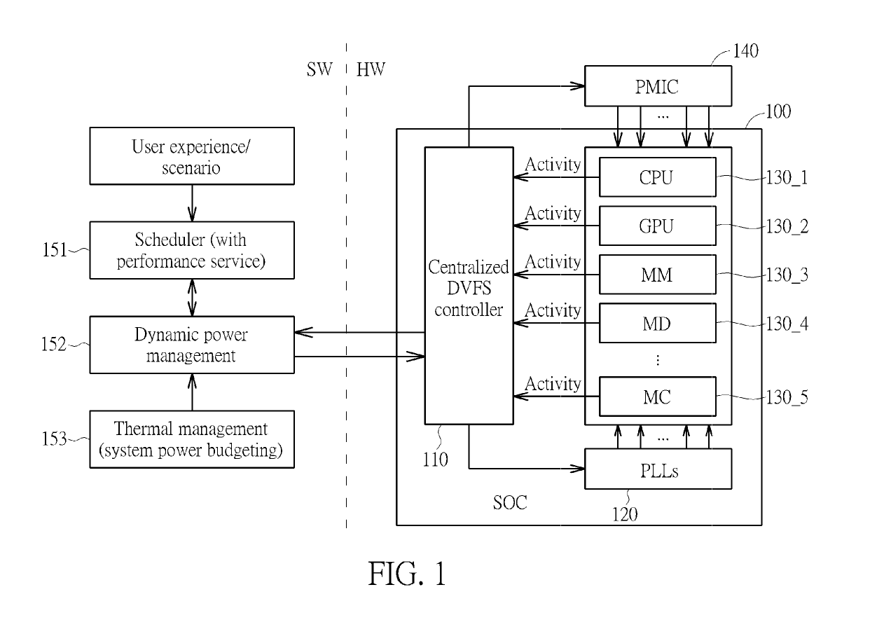

Please refer to FIG. 1, which is a diagram illustrating a system on chip (SOC) 100 according to one embodiment of the present invention. As shown in FIG. 1, the SOC 100 comprises a centralized DVFS controller 110, a plurality of phased-locked loops (PLLs) 120 and a plurality of hardware modules, where the hardware modules comprises, not limited to, a central processing unit (CPU) 130_1, a graphics processing unit (GPU) 130_2, a multimedia module (MM) 130_3, a modulator-demodulator (MD) 130_4, a memory controller (MC) 130_5 and bus interconnection.

The SOC 100 further couples to a power management integrated circuit (PMIC) 140 that is arranged to provide supply voltages to the hardware modules. In addition, in this embodiment the PMIC 140 is position outside the SOC 100, however, the PMIC 140 may be positioned in the SOC 100.

The SOC 100 is used in an electronic device, such as a smart phone, a tablet or any other device having several processors, to control the operations of the electronic device. Besides the hardware (HW) side, FIG. 1 also shows a software (SW) side that is used to guide the policy of the centralized DVFS controller 110. On the software side, it shows three modules: a scheduler 151, a dynamic power management 152 and a thermal management 153. The scheduler 151 is used to arrange the tasks based on the user experience and/or scenarios and other conditions to optimize the utilizations, and the scheduler 151 further provides DVFS operating performance points (OPPs, i.e. clock frequency and/or supply voltage) information, utilization information, DVFS ceiling (e.g. upper limit of the clock frequency) and DVFS floor (e.g. lower limit of the clock frequency) to the dynamic power management 152. The thermal management 153 is used to provide information of a DVFS ceiling, a system power budgeting, and/or a battery condition to the dynamic power management 152. Based on the information received from the scheduler 151 and the thermal management 153, the dynamic power management 152 sends at least a portion of the aforementioned information to the centralized DVFS controller 110. In addition, in one embodiment, the dynamic power management 152 may also send information about frames per second (FPS), chip corner condition, and/or ambient temperature, which may influence the DVFS policy, to the centralized DVFS controller 110.

In this embodiment, the centralized DVFS controller 110 is a hardware DVFS controller that may approach fast DVFS operations. The centralized DVFS controller 110 may receive software information from the dynamic power management 152, and receive activities of the CPU 130_1, GPU 130_2, MM 130_3, MD 130_4 and MC 130_5. The centralized DVFS controller 110 is arranged to provide voltage control signal(s) to the PMIC 140 to control/adjust supply voltages of the CPU 130_1, GPU 130_2, MM 130_3, MD 130_4 and MC 130_5, respectively, based on the software information and the activities of the hardware modules; and the centralized DVFS controller 110 is further arranged to provide PLL control signal(s) to the PLLs 120 to control/adjust clock frequencies of the CPU 130_1, GPU 130_2, MM 130_3, MD 130_4 and MC 130_5, respectively, based on these software information and the activities of the hardware modules.

It is noted that the centralized DVFS controller 110 can be implemented by functional circuits, and could act as a microprocessor, or a digital signal processor. Thus, the centralized DVFS controller 110 can operate more automatically without instructed by a host (such as a CPU), and the host can save burden to avoid software overhead/loading. Moreover, by such kind of implementations, the centralized DVFS controller 110 can operate more efficiently without waiting for host instructions.

In addition, the activity of a hardware module comprises a loading and/or a utilization and/or bandwidth of the hardware module, for example the activity of the CPU 130_1 is the loading/utilization of the CPU 130_1, and the activity of the GPU 130_2 is the loading/utilization of the GPU 130_2, and so on. Particularly, in this embodiment, the activities come from signals of the CPU 130_1, GPU 130_2, MM 130_3, MD 130_4 and MC 130_5. That is the centralized DVFS controller 110 directly gets the activities of the CPU 130_1, GPU 130_2, MM 130_3, MD 130_4 and MC 130_5 via the connections (such as wire connection) within the SOC 100, instead of from the software side.

In this embodiment, there is a dedicated channel set between the centralized DVFS controller 110 and the PMIC 140 to reduce response time of voltage switch, and the centralized DVFS controller 110 may send the voltage control signal(s) to the PMIC 140 via the dedicated channel to fast switch the supply voltage(s) of the CPU 130_1, GPU 130_2, MM 130_3, MD 130_4 and/or MC 130_5.

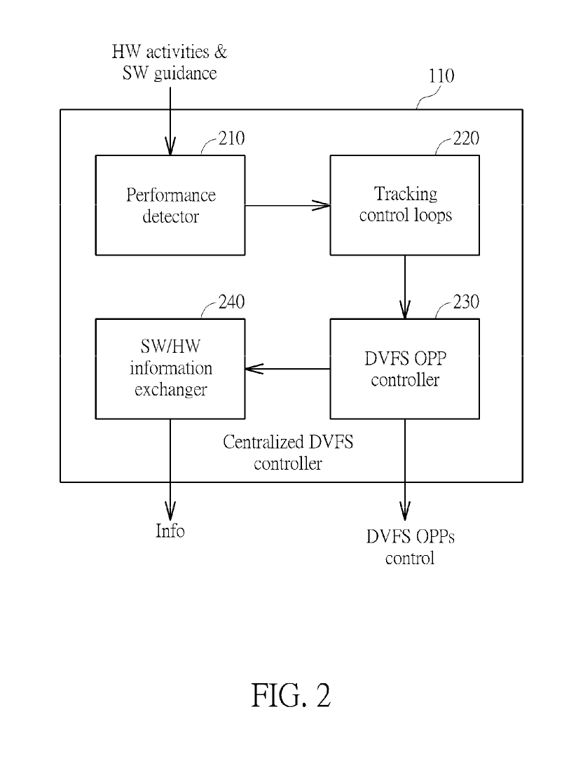

FIG. 2 is a diagram illustrating the centralized DVFS controller 110 according to one embodiment of the present invention. As shown in FIG. 2, the centralized DVFS controller 110 comprises a plurality of functional circuits, such as a performance detector 210, a plurality of tracking control loops 220, a DVFS OPP controller 230 and a SW/HW information exchanger 240. For the performance detector 210, the performance detector 210 receives the HW activities (i.e. the activities of the hardware modules) in real time to collect instant performance requirement, and overall arranges and optimizes the DVFS OPP targets for each of the hardware modules based on the HW activities. In addition, the performance detector 210 also receives the SW guidance (i.e. the software information from the dynamic power management 152) to guide or command DVFS OPP or power down a specific hardware module based on the user experience, scenarios and thermal condition.

For the tracking control loops 220 shown in FIG. 2, each hardware module may have individual tracking control loop to automatically maximize the utilization on its performance target for different user scenarios, and each tracking control loop is used to determine the OPPs of the corresponding hardware module; or several hardware modules may share the same tracking control loop.

For the DVFS OPP controller 230, the DVFS OPP controller 230 may provide the voltage control signal(s) to the PMIC 140 to control/adjust supply voltages of the hardware modules, respectively, based on the OPPs determined by the tracking control loops 220; and the DVFS OPP controller 230 provides PLL control signal(s) to the PLLs 120 to control/adjust clock frequencies of the hardware modules, respectively, based on the OPPS determined by the tracking control loops 220. In addition, the DVFS OPP controller 230 adopts an adaptive voltage scaling (AVS) technology according to the chip corner condition and the ambient temperature.

For the SW/HW information exchanger 240, the SW/HW information exchanger 240 may provide a history record of the DVFS operation such as a coarse-grained frequency (e.g. an average of the clock frequencies within a long period, such as 30 ms) to the SW side for general SW framework. The SW/HW information exchanger 240 can send an interrupt to the SW side when instantly dramatic DVFS OPP changes; and/or the SW side can periodically get frequency/loading information (such as moving average) by polling.

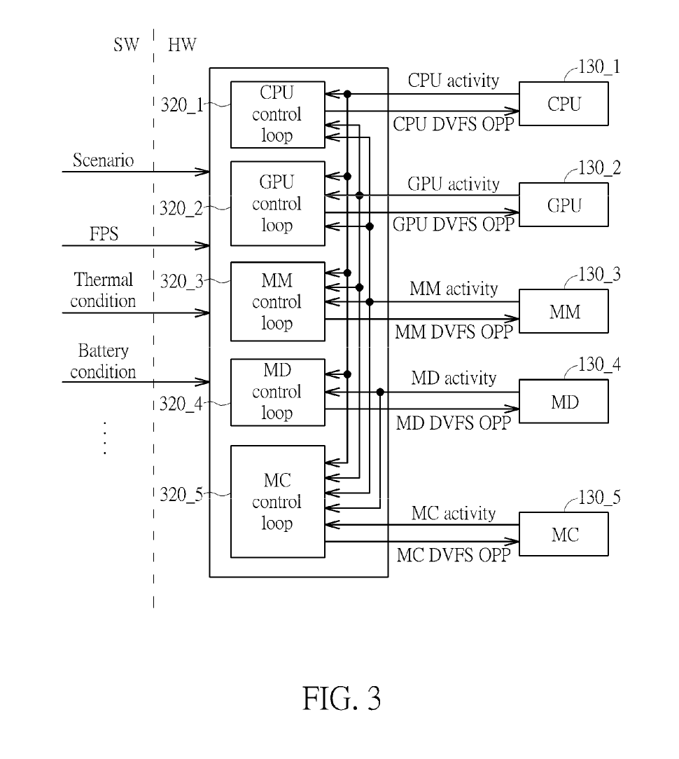

FIG. 3 shows an overall arrangement of the DVFS OPPs according to one embodiment of the present invention, and it is noted that the PLLs 120, the PMIC 140, performance detector 210, the DVFS OPP controller 230 and the SW/HW information exchanger 240 are not shown in FIG. 3 for brevity. In FIG. 3, it is assumed that the tracking control loops 220 shown in FIG. 2 comprise a CPU control loop 320_1, a GPU control loop 320_2, a MM control loop 320_3, a MD control loop 320_4 and a MC control loop 320_5.

As show in FIG. 3, the CPU control loop 320_1 may receive CPU activity, GPU activity and MM activity to determine a CPU DVFS OPP for producer and consumer optimization to avoid over-reacting or slow-reacting and balance system resources, and send the voltage control signal and the PLL control signal corresponding to the CPU DVFS OPP to the PMIC 140 and the PLLs 120, respectively, to control/adjust the clock frequency and the supply voltage of the CPU 130_1. The GPU control loop 320_2 may receive CPU activity, GPU activity and MM activity to determine a GPU DVFS OPP, and send the voltage control signal and the PLL control signal corresponding to the GPU DVFS OPP to the PMIC 140 and the PLLs 120, respectively, to control/adjust the clock frequency and the supply voltage of the GPU 130_2. The MM control loop 320_3 may receive CPU activity, GPU activity and MM activity to determine a MM DVFS OPP, and send the voltage control signal and the PLL control signal corresponding to the MM DVFS OPP to the PMIC 140 and the PLLs 120, respectively, to control/adjust the clock frequency and the supply voltage of the MM 130_3. The MD control loop 320_4 may receive CPU activity and MD activity to determine a MD DVFS OPP, and send the voltage control signal and the PLL control signal corresponding to the MD DVFS OPP to the PMIC 140 and the PLLs 120, respectively, to control/adjust the clock frequency and the supply voltage of the MD 130_4. The MC control loop 320_5 may receive CPU activity, GPU activity, MM activity, MD activity and MC activity to determine a MC DVFS OPP, and send the voltage control signal and the PLL control signal corresponding to the MC DVFS OPP to the PMIC 140 and the PLLs 120, respectively, to control/adjust the clock frequency and the supply voltage of the MC 130_5.

In the embodiments shown in FIG. 3, the DVFS OPP of a specific hardware module are determined based on the activities of the specific hardware module and at least a portion of other hardware modules. Therefore, the control loops 320_1-320_5 can determine the DVFS OPPs for the hardware modules more accurately. Followings are two examples for the overall arrangements shown in FIG. 3. When CPU 130_1 is busy and the loading of the CPU 130_1 is high, it may indicate that the cache miss is increasing, and the loading of the MC 130_5 may be going up immediately even if the current loading of the MC 130_5 is not heavy. Therefore, the MC control loop 320_5 may send the voltage control signal and the PLL control signal to the PMIC 140 and the PLLs 120, respectively, to raise the clock frequency and the supply voltage of the MC 130_5. In addition, when the loading of the GPU 130_2 increases, it may indicate that the loading of the CPU 130_1 is going to increase even if the current loading of the CPU 130_1 is not heavy, therefore, the CPU control loop 320_5 may send the voltage control signal and the PLL control signal to the PMIC 140 and the PLLs 120, respectively, to raise the clock frequency and the supply voltage of the CPU 130_1.

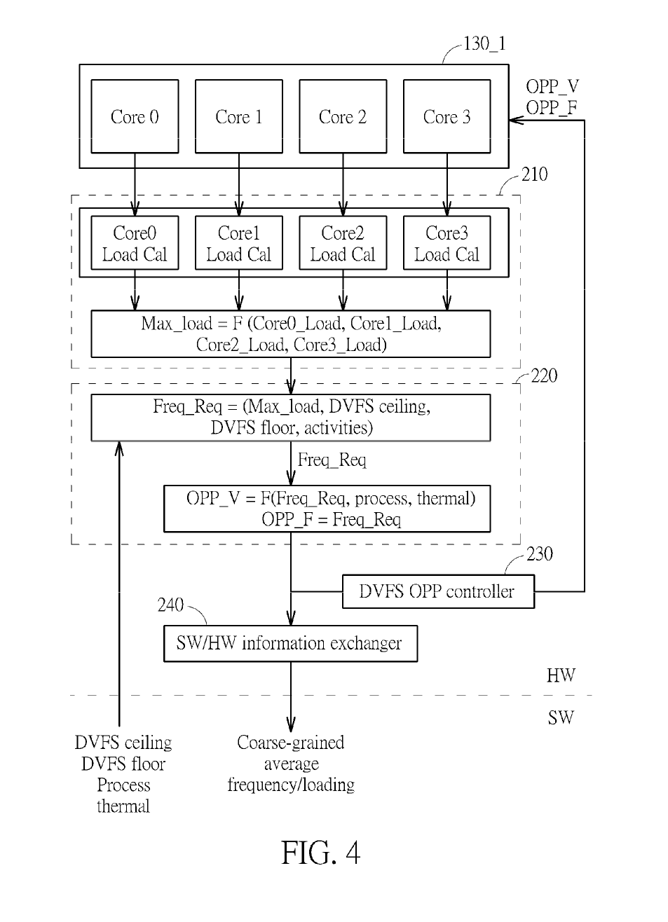

FIG. 4 is a diagram illustrating the detailed operations of the embodiment shown in FIG. 2, and is using CPU as an example. As shown in FIG. 4, the CPU 130_1 has four cores: Core 0, Core 1, Core 2 and Core 3, and the performance detector 210 detects the loadings of the four cores, respectively, to obtain the four loadings: Core0_Load, Core1_Load, Core2_Load and Core3_Load; and the performance detector 210 determines a maximum loading Max_load by referring to the Core0_Load, Core1_Load, Core2_Load and Core3_Load, that is Max_load=F (Core0_Load, Core1_Load, Core2_Load, Core3_Load). Then, the CPU control loop 320_1 of the tracking control loop 220 determines a required clock frequency Freq_Req according to Max_load, DVFS ceiling, DVFS floor and activities of the other hardware modules, that is Freq_Req=F (Max_load, DVFS ceiling, DVFS floor, activities); and the CPU control loop 320_1 determines the supply voltage OPP_V according to Freq_Req, process and the thermal/temperature parameters, that is OPP_V=F (Freq_Req, process, thermal), and determines the clock frequency OPP_F as the required clock frequency Freq_Req. Finally the DVFS OPP controller 230 sends the OPP_V and OPP_F to the PMIC 140 and the PLLs 120 to control/adjust the clock frequency and the supply voltage of the CPU 130_1 if the clock frequency and the supply voltage of the CPU 130_1 need to change; and the SW/HW information exchanger 240 sends a coarse-grained average frequency/loading to the SW side.

In one embodiment, not a limitation of the present invention, the supply voltage OPP_V and the clock frequency OPP_F may be determined every millisecond (1 ms) or smaller, and the coarse-grained average frequency may be average of the clock frequency within 30 ms.

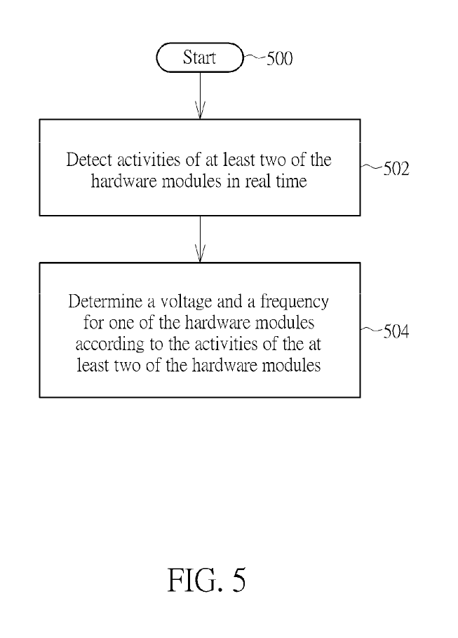

FIG. 5 is a flowchart of a method for controlling a plurality of hardware modules according to one embodiment of the present invention. Refer to FIGS. 1-5 together, the flow is as follows.

Step 500: the flow starts.

Step 502: detect activities of at least two of the hardware modules in real time.

Step 504: determine a voltage and a frequency for one of the hardware modules according to the activities of the at least two of the hardware modules.

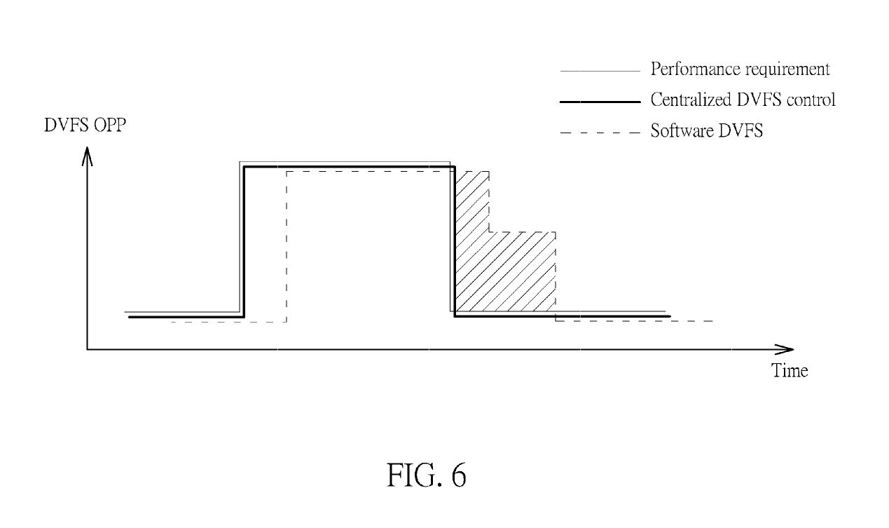

The centralized DVFS controller 110 shown in FIG. 1 is implemented by hardware, and the centralized DVFS controller 110 can use a higher sampling rate to rapidly control the DVFS OPPs of the hardware modules. In detail, FIG. 6 shows a diagram illustrating the distinction between the performance requirement, the DVFS OPP status controlled by the centralized DVFS controller 110, and the DVFS OPP status controlled by a software DVFS controller according to one embodiment of the present invention. As shown in FIG. 6, the centralized DVFS controller 110 can rapidly raise DVFS OPP to follow the performance requirement of the hardware module(s), and swiftly lower DVFS OPP for power saving when the performance requirement is lowered. The software DVFS is not able to immediately follow the performance requirement, and the shading area shown in FIG. 6 is the power saving between the centralized DVFS controller 110 and the software DVFS controller.

Briefly summarized, in the embodiments of the present invention, a hardware DVFS controller is used to fast control the DVFS OPP of the hardware modules, and the SW overhead can be avoided. In addition, the hardware DVFS controller further manage the supply voltages and clock frequencies of the hardware modules by referring to the conditions of the whole system, that is the DVFS OPP control of each hardware module may be more accurately.

Those skilled in the art will readily observe that numerous modifications and alterations of the device and method may be made while retaining the teachings of the invention. Accordingly, the above disclosure should be construed as limited only by the metes and bounds of the appended claims.

1. A controller, coupled to a plurality of hardware modules, for detecting activities of at least two of the hardware modules in real time, and determining a voltage and a frequency for one of the hardware modules according to the activities of the at least two of the hardware modules.

2. The controller of claim 1, wherein the hardware modules comprises at least two of a central processing unit (CPU), a graphics processing unit (GPU), a multimedia module, a modulator-demodulator and a memory controller.

3. The controller of claim 1, wherein the controller is a dynamic voltage frequency scaling (DVFS) controller implemented by functional circuits.

4. The controller of claim 3, wherein the DVFS controller further receives software information from a software side, and determines the voltage and the frequency for one of the hardware modules according to the activities of the at least two of the modules and the software information.

5. The controller of claim 4, wherein the software information comprises at least one of user experience, scenarios, thermal condition, frames per second (FPS), DVFS ceiling, DVFS floor and battery condition.

6. The controller of claim 3, wherein the DVFS controller sends coarse-grained frequency of the hardware modules to the software side.

7. The controller of claim 1, wherein the activity of one of the hardware modules is a loading of the hardware module.

8. The controller of claim 1, wherein the controller detects the activities of the hardware modules through wire connection respectively.

9. The controller of claim 1, wherein the controller sends the determined voltages to a power management integrated circuit (PMIC) via a dedicated channel to control/adjust supply voltages of the hardware modules, respectively.

10. A method for controlling a plurality of hardware modules, comprising:
detecting activities of at least two of the hardware modules in real time; and
determining a voltage and a frequency for one of the hardware modules according to the activities of the at least two of the hardware modules.

11. The method of claim 10, wherein the hardware modules comprises at least two of a central processing unit (CPU), a graphics processing unit (GPU), a multimedia module, a modulator-demodulator and a memory controller.

12. The method of claim 10, wherein the method is performed by a dynamic voltage frequency scaling (DVFS) controller implemented by functional circuits.

13. The method of claim 10, wherein the activity of one of the hardware modules is a loading of the module.

14. The method of claim 10, wherein the activities of the hardware modules are detected through wire connection respectively.

15. The method of claim 10, further comprising:
sending the determined voltages to a power management integrated circuit (PMIC) via a dedicated channel to control/adjust supply voltages of the hardware modules, respectively.

16. A controller, comprising:
a performance detector, for detecting activities of a plurality of hardware modules;
a plurality of tracking control loops coupled to the performance detector, wherein each of the tracking control loops is arranged to respectively determine a voltage or a frequency for each corresponding hardware module according to the detected activities; and
an operating performance points (OPP) controller, coupled to the tracking control loops, for controlling the hardware modules based on the determined voltages or frequencies corresponding to the hardware modules.

17. The controller of claim 16, wherein each of the tracking control loops determines the voltage or the frequency for the corresponding hardware module according to the activities of at least two of the hardware modules.

18. The controller of claim 16, wherein the performance detector, the tracking control loops and the OPP controller are implemented by functional circuits; the performance detector further receives software information from a software side, and each of the tracking control loops determines the voltage or the frequency for the corresponding hardware module according to the activity of the hardware module and the software information.

19. The controller of claim 16, wherein the activity of one of the hardware modules is a loading of the hardware module.

20. The controller of claim 16, further comprising:
a software/hardware information exchanger, coupled to the OPP controller, for sending coarse-grained frequency of the hardware modules to a software side.
